(19) United States
(12) Patent Application Publication
(10) Pub. No.: US 2002/0120588 A1
(43) Pub. Date: Aug. 29, 2002

(54) Method and apparatus for negotiation

(76) Inventors: Christopher William Preist, Bristol (GB); Claudio Bartolini, Bristol (GB)

Correspondence Address: HEWLETT-PACKARD COMPANY, Intellectual Property Administration, P.O. Box 272400, Fort Collins, CO, 80527-2400, US

(21) Appl. No.: 10/035,700

(22) Filed: Oct. 29, 2001

(30) Foreign Application Priority Data
Nov. 3, 2000 (GB) 0027014.0

(51) Int. Cl. G06F 17/60; H04L 9/00

(52) U.S. Cl. 705/80

(57) ABSTRACT

A computer system for allowing negotiation between a plurality of entities, the computer system comprising a computer network having a plurality of computer nodes; a computer node being arranged to define the negotiation between the entities with a set of negotiation activities; wherein the computer node is operable to implement a plurality of negotiation rule sets, each rule set constraining the negotiation activities to a specific negotiation type, thereby allowing a plurality of negotiation types to be selected by an entity.

### TECHNICAL FIELD

The present invention relates to computer systems for allowing negotiation, and to corresponding computer nodes and communication methods.

### BACKGROUND ART

With the increasing importance of business-to-business electronic trading, the interest in automated negotiation has increased significantly.

Existing approaches to enabling automated negotiation provides either ad-hoc solutions for particular market mechanisms or proprietary solutions.

This can result in user's having to have a number of different software applications to support different market mechanisms, for example one application may be required to support negotiation in a English auction, while another application may be needed to support one to one negotiation. This can result in increased complexity and increased user uncertainty with regard to how the different applications support the users during the negotiation process.

It is desirable to improve this situation.

### SUMMARY OF INVENTION

In accordance with a first aspect of the present invention there is provided a computer system for allowing negotiation between a plurality of entities, the computer system comprising a computer network having a plurality of computer nodes; a computer node being arranged to define the negotiation between the entities with a set of negotiation activities; wherein the computer node is operable to implement a plurality of negotiation rule sets, each rule set constraining the set of negotiation activities to a specific negotiation type, thereby allowing an entity to select at least one of a plurality of negotiation types.

This seeks to provide efficiency in the automation of the negotiation process by standardising the basic activities in any negotiation. This can reduce the effort required to automate many different kinds of business interactions.

Further this can provide users with some confidence that no party involved in a transaction has access to additional information.

Additionally, it allows negotiation hosts to provide a standard framework that all potential customers can use to interact with them without requiring a specific market mechanism, so allowing the host to decide on an appropriate market mechanism.

Preferably a plurality of nodes are arranged to define the negotiation between the entities with a set of negotiation activities; wherein each of the plurality of nodes are operable to implement a plurality of negotiation rule sets.

Preferably at least one of the entities is a software negotiation agent.

Preferably the computer node incorporates the software negotiation agent.

Preferably at least one of the entities is a user.

Suitably at least one of the entities is a negotiation host and at least another of the entities is a negotiation participant.

Suitably at least one of the rule sets constrains the negotiation activities to an auction and at least another rule set constrains the negotiation activities to a one on one negotiation.

Preferably the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

Preferably the negotiation activities further includes a protocol enforcer for rejecting invalid proposals.

Preferably the negotiation activities further includes an information editor for providing to the negotiation locale summarized proposal information.

Preferably the negotiation activities further includes an agreement maker for determining criteria for establishing an agreement based on the received proposals.

In accordance with a second aspect of the present invention there is provided a computer node for coupling to a computer system to allow negotiation between a plurality of entities, the computer node comprising a processor, the processor being arranged to define the negotiation between the entities with a set of negotiation activities; wherein the processor is operable to implement a plurality of negotiation rule sets, each rule set constraining the set of negotiation activities to a specific negotiation type, thereby allowing an entity to select at least one of a plurality of negotiation types.

In accordance with a third aspect of the present invention there is provided a method for selecting a negotiation type between a plurality of entities via a computer network having a plurality of computer nodes, the method comprising defining in a computer node a set of negotiation activities; allowing an entity to select via the computer node at least one of a plurality of negotiation rule sets, each rule set constraining the set of negotiation activities to a specific negotiation type, thereby allowing an entity to select at least one of a plurality of negotiation types.

In accordance with a fourth aspect of the present invention there is provided a computer system for allowing negotiation between a plurality of entities, the computer system comprising a computer network having a plurality of computer nodes; a computer node being arranged to define the negotiation between the entities with a set of negotiation activities; wherein the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

In accordance with a fifth aspect of the present invention there is provided a computer node for coupling to a computer system to allow negotiation between a plurality of entities, the computer node comprising a processor, the processor being arranged to define the negotiation between the entities with a set of negotiation activities; wherein the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

### BRIEF DESCRIPTION OF DRAWINGS

The present invention will now be described, by way of example only, with reference to the drawings that follow; in which:

FIG. 1 is a schematic illustration of an apparatus according to an embodiment of the present invention;

FIG. 2 is a schematic illustration of the functional units of a negotiation host for use in embodiments of the present invention;

FIG. 3 is a diagrammatic illustration of an overview of a method according to an embodiment of the present invention;

### DETAILED DESCRIPTION

Negotiation is the process by which two or more parties interact to reach an agreement. Usually this will be about some business interaction such as a contract for the supply of a service in return for payment, though the present invention is not limited to negotiations associated with contractual agreements.

This embodiment describes below a general protocol for negotiation between two or more parties. The protocol is parameterised by a set of rules. By choosing a specific set of rules to enforce a negotiation a negotiation host can create a specific market mechanism.

The negotiation protocol, described below, can be supported using messaging middleware, for example, the Java™ Message Service (JMS). Examples of industrial systems implementing JMS are Progress Software SonicMQ and IBM MQSeries. Open source JMS systems such as JbossMQ from Jboss.org are also available.

Alternatively, the protocol can be layered on top of a message transport service.

To enable participants to negotiate with one another an agreement template is defined, usually but not necessarily by the negotiation host. The negotiation template specifies the different parameters of the negotiation such as, for an agreement for the supply of goods, product type, price, supply, date etc. Some parameters may be constrained within the template, for instance product type will nearly always be tightly constrained, whereas others may be specified as a range or limit (eg supply date), or left completely open (eg price).

As part of the admission process of participants to the negotiation, they are requested to accept a agreement template. The admission step might be formalized by the specification of admission policies. The admission policies can specify what credentials (if any) are requested from participants for them to be admitted to the negotiation.

Depending on what parameters a party is willing to negotiate on, it will adopt more or less constrained agreement templates. For example, a party that is willing to negotiate nothing (such as a catalogue) will only advertise a fully instantiated agreement template, with a fixed price. A party willing to negotiate features of a product, such as colour, as well as price and delivery date, will leave these parameters unconstrained.

The process of negotiation is the move from an agreement template to an agreement, which the agreeing parties find acceptable. A single negotiation may involve many parties, resulting in several agreements between different parties and some parties who do not reach agreement. For example, a stock exchange can be viewed as a negotiation where many buyers and many sellers meet to negotiate the price of a given stock. Many agreements are formed between buyers and sellers, and some buyers and sellers fail to trade.

In the process of reaching agreements, the negotiation participants exchange proposals representing the deals that are currently acceptable to them. Each proposal will contain constraints over some of the parameters expressed in the agreement template.

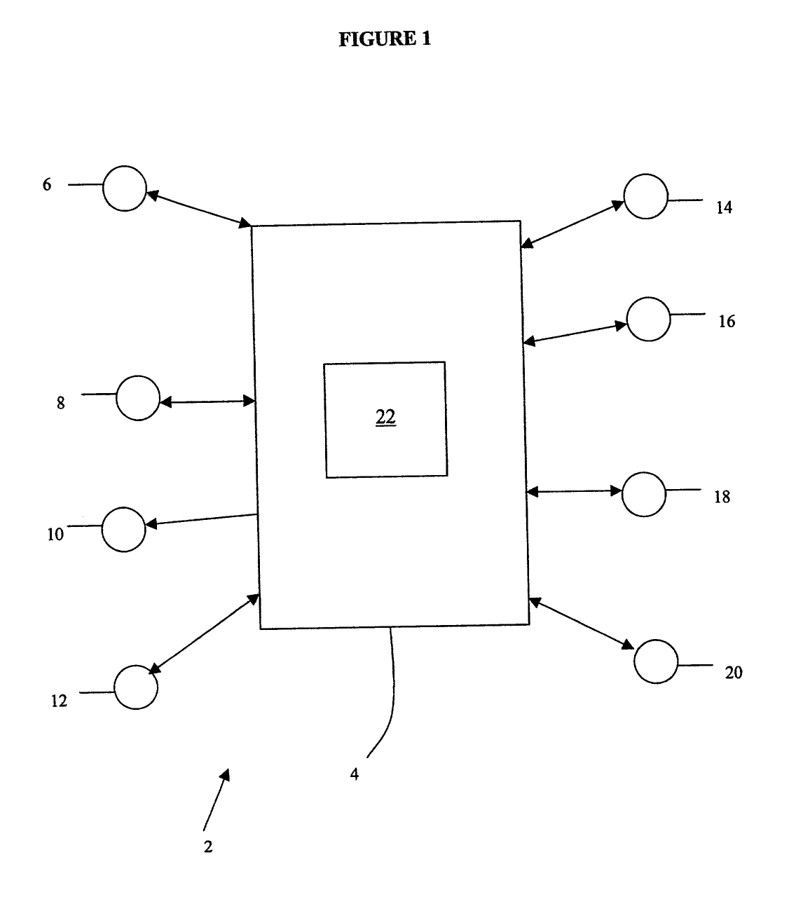

Referring to FIG. 1 of the accompanying drawings there is shown a computer system 2 comprising a plurality of computer nodes 4-20. In this embodiment computer nodes 6-20 communicate with each other via computer node 4, which is a software negotiation agent, using the internet (not shown), though other communication methods and routes can be utilised. Computer node 4 comprises a processor 22 programmed and configured to operate according to the present invention.

Each computer node 4-20 represents an entity that is a possible party to a negotiation. One or more computer nodes 4-20 may represent a user, though the present invention is also suited to automatic, computer controlled negotiations.

In this embodiment, computer node 4 acts as a negotiation host. The negotiation host is typically the role responsible for enforcing the protocol and enforcement of rules governing negotiation, for example participation, execution, resolution and termination of a negotiation. The negotiation host 4 may have some, or all, of the following sub-roles/activities:

Gatekeeper role for enforcing the policies governing admission to a negotiation.

Infrastructure provider role for providing the underlying communications infrastructure of the negotiation locale. The infrastructure provider forwards proposals and information updates, according to the visibility rules defined by the negotiation host.

Proposal validator role for ensuring that a proposal is well formed with respect to the agreement template.

Protocol enforcer role for ensuring that participants' proposals are posted and withdrawn according to the negotiation rules.

Agreement maker role for agreement formation.

Information updater role for notifying participants of the current state of the negotiation, according to the display rules.

As described below, negotiation may take place between two entities where one of the entities is represented by the negotiation host 4, as in one to one negotiation; or the negotiation host 4 can act as a controlling third party, as in an English auction. Alternatively, a number of the computer nodes 4-20 can participate in a multi-party negotiation to form a multi-party agreement.

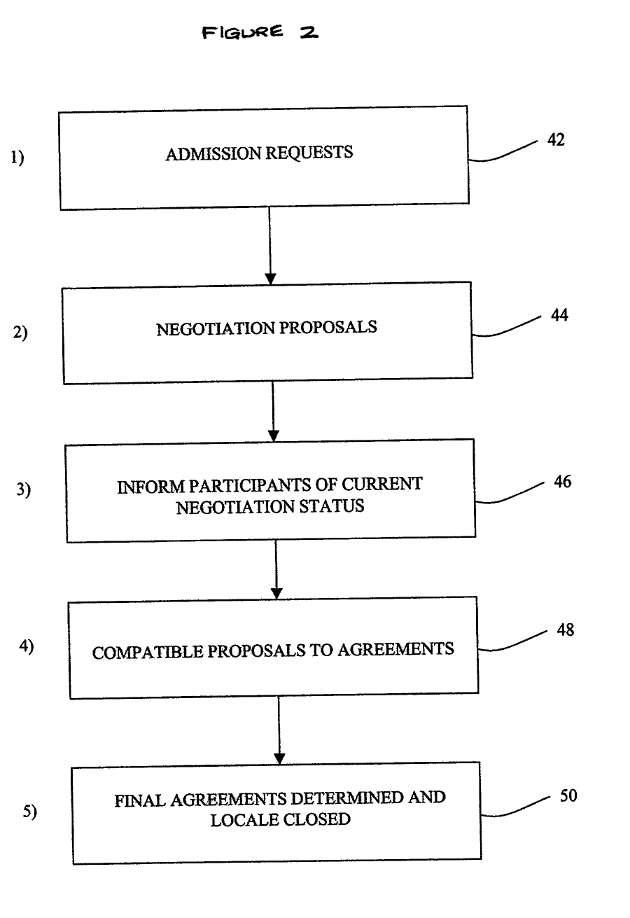

Referring to FIG. 2 of the accompanying drawings, the negotiation protocol consists of five stages:

Stage 1—Potential participants make requests of the negotiation host for admission to the negotiation (42).

Stage 2—Negotiation takes place by proposals being made by the participants (44).

Stage 3—The negotiation host informs the participants of the current status of the negotiation (46).

Stage 4—The negotiation host identifies compatible proposals and converts them to agreements (48).

Stage 5—Any final agreements are determined and the negotiation host closes the negotiation locale (50).

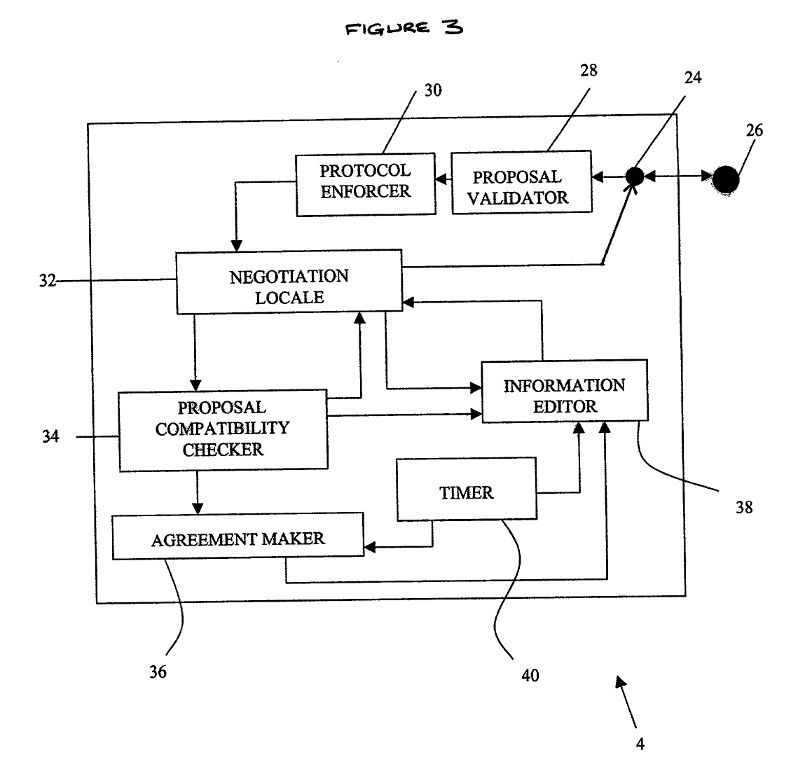

Referring to FIG. 3 of the accompanying drawings, the functional blocks of the computer node 4 are shown in more detail.

Computer node 4 comprises a data input/output port 24 for receiving data from data source 26, typically communications from the other computer nodes 6-20. Incoming data to port 24 is provided to proposal validator 28 for validating proposals against an agreement template and to a protocol enforcer 30 for rejecting invalid proposals. A negotiation locale 32 receives validated proposals and communicates part or all of them to the relevant party or parties via port 24. Negotiation locale 32 communicates with proposal compatibility checker 34, which compares proposals posted to the negotiation locale 32 to determine whether a compatible set of proposals have been made. Agreement maker 36 receives compatible proposals from proposal compatibility checker 34 and optimises an agreement. An information editor 38 summarises information regarding the negotiation process from negotiation locale 32, proposal compatibility checker 34, agreement maker 36 and a timer 40 for feeding it back to the negotiation locate 32. Timer 40 provides general and elapsed time information for the process to agreement maker 36 and information editor 38.

Negotiation takes place by parties communicating through the negotiation locale. The negotiation locale is an abstraction over the messaging system that is used by negotiation participants to address each other where the negotiation locale, typically, has an agreement template associated with it. The agreement template defines the subject of negotiation within the negotiation locale.

After admission to negotiation, a participant is given access to the negotiation locale. This locale may already exist, or may be created specifically for this new negotiation. Along with the access, the participant is given a mailbox where messages encoding negotiation proposals will be delivered. Each participant can send proposals by broadcasting them to the negotiation locale. Reliable delivery and security will be enforced by the underlying messaging infrastructure. Singling out a counterpart can be achieved by limiting the visibility of the broadcast message, in case the market mechanism rules allow it. That allows us to model one-to-one negotiation as a particular case of many-to-many.

The negotiation participant participates in a negotiation by posting proposals according to the rules provided by the negotiation host.

These proposals are sent to the negotiation locale, and can then be viewed by other negotiation participants. However, before a proposal is distributed by the locale, it must be valid.

Each time a participant submits a proposal by posting it to the negotiation locale, the negotiation host, in the role of proposal validator, validates the proposal against the agreement template. It checks that the proposal is a constrained form of the agreement template, and is syntactically well formed. That is the constraints over the parameters in the proposal must be tighter that the corresponding ones in the agreement template. The constraints represent acceptable values to the proposing participant. (Often, these constraints will be a single acceptable value of a parameter).

If the proposal is not valid, then it is rejected. If the proposal passes this first stage of validation, then the negotiation host (playing here the role of protocol enforcer) validates the proposal against the negotiation rules. The negotiation rules define the way in which the negotiation should take place, and may include restrictions on when a proposal can be made (e.g. participants must take turns to submit) and semantic requirements on valid proposals (e.g. requirements that a proposal must improve on previous ones).

If the proposal passes this second stage of validation, then the current set of proposals and associated data structures are updated accordingly and participants are notified. Who is notified, and the structure of the notification, is defined by visibility rules and information filtering rules.

The negotiation host (this time in the agreement maker role) then looks at the current set of proposals to determine whether agreements can be made. Agreements can potentially occur whenever two or more negotiating parties make compatible proposals. In this case, agreement formation rules determine exactly which proposals are matched with each other, and the final instantiated agreement that will be used. Agreement rules may state, for example, that the highest priced offer to buy should be matched with the lowest priced offer to sell, and that the final agreement will take place at the average price. Often, ‘tie breaking’ agreement rules will be defined that will be used if the main agreement rules can be applied in several ways. For example, earlier posted offers may take priority over later ones.

The participants now exchange proposals until termination is reached. Agreement formation can occur at any time (for example when two proposals are matched in a continuous double auction). Agreement formation may trigger termination (e.g. one-to-one negotiation) or may not (e.g. continuous double auction).

One example of a set of negotiation activities that can be utilised to form a general protocol is the following:

Posting

This includes negotiation rules that determine the circumstances in which a participant may post a proposal.

Visibility

This includes negotiation rules that specifying who, among the participants, has visibility over a submitted proposal.

Display

This includes negotiation rules that specify if and how an information updater notifies the participants that a proposal has been submitted or an agreement has been made—either by transmitting the proposal unchanged or by transmitting a summary of the situation.

Improvement

This includes negotiation rules that specify what new proposals may be posted for a given set of existing proposals.

Withdrawal

This includes negotiation rules that specify if and when proposals can be withdrawn from negotiation, and policies over the expiration time of proposals.

Termination

This includes negotiation rules that specify when no more proposals may be posted (e.g. a given time, period of quiescence, etc.).

Agreement Formation

This includes negotiation rules that are responsible for determining, given a set of proposals at least one pair of which intersect, which agreements should be formed.

Tie-Breaking

A specific set of agreement formation rules applied after all others.

An implementation described below illustrates the use of the general protocol to define, using the above set of activities with a number of associated negotiation rule sets, a number of different market mechanisms. The market mechanisms illustrated are: a simple shop front, an English auction and a continuous double auction. However, other negotiation rule sets can be used for other market mechanisms, for example dutch auction, sealed bid auction, vickrey auction, reverse auction and open-cry auction. Alternatively, different set of activities can be used with their own set of negotiation rule sets.

For a simple shop front negotiation the actors (i.e. entities) involved are the shopkeeper and one or more buyers. A buyer plays the participant role, whereas the shopkeeper plays both the participant and the negotiation host roles at the same time. The shop front is modelled by the negotiation locale abstraction.

Before negotiation begins, the shopkeeper decides the admission policy, negotiation template, negotiation and agreement formation rules in accordance with standard set of activities. For example:

Admission Policy

This will usually be the null policy: anyone is admitted.

Negotiation Template

The shopkeeper decides on templates of goods it is willing to sell. These will be fully defined, specifying all details exactly, including price. To be valid with respect to the negotiation template, a buyer's proposal must therefore be an exact copy of the seller's proposal (except it is ‘buy’ rather than ‘sell’).

Negotiation Rules

The shopkeeper adopts ‘shop front take it or leave it’ negotiation rules. These state that:

Posting rule—A buyer may post a proposal at any time, irrespective of posted proposals by other buyers. A seller may post or withdraw proposals at any time.

Termination rule—Termination occurs when there are no seller proposals posted in the shop front

Agreement Formation Rules

The shopkeeper adopts shop front agreement formation rule:

Agreement formation rule—Agreements are formed whenever a buyer posts a proposal identical to the seller's proposal.

After the rules have been specified, negotiation can begin. The shopkeeper submits proposals for all goods it sells. If it expects high demand, it can place several identical proposals on the table for the same good. If all proposals for a given good are accepted, and the shopkeeper still has more in stock, it resubmits identical proposals. A buyer submits a proposal, an identical copy of the shopkeeper's proposal, when it wishes to purchase a given good. Agreement formation occurs as the shopkeeper—in the negotiation host role—identifies valid buyer proposals and sends agreements to the buyers.

For an English auction the actors (i.e. entities) involved are a seller and various buyers in the role of participants. The auctioneer that auctions the item on behalf of the seller plays the negotiation host role. The auction room is modelled as a negotiation locale. An example of admission policy, negotiation template and negotiation and agreement formation rules are:

Admission Policy

Auctioneer and seller decide the policy. This could be the null policy—anyone is admitted—or they could restrict admission to a number of invitees on presentation of an invitation certificate (participant's credential).

Negotiation Template

The seller decides on the template of the good it is selling. This will be fully defined, specifying all details exactly, except for the price attribute, which will be constrained to be greater than an initial reservation price. To be valid with respect to the negotiation template, a buyer's proposal must therefore be an exact copy of the seller's proposal except for having a price that is higher than what is specified in the negotiation template as initial reservation price.

Negotiation Rules

The auctioneer adopts English auction negotiation rules. These state that:

Posting rule—A buyer may post a proposal at any time.

Improvement rule—The price field of the buyer's proposal must be a certain increment above the value of all previously posted buyer proposals

Withdrawal rule—It is not possible to withdraw a proposal that represent the currently highest bid.

Visibility rule—The proposals that buyers submit are visible to all the participants.

Termination rule—Termination occurs at a fixed time or after a period of inactivity

Agreement Formation Rules

The auctioneer adopts the English auction agreement formation rule, that states:

Agreement formation rule—After termination, an agreement between the highest bidding buyer and the seller is formed for the item fully specified in the template to be sold to the buyer at the price specified in the highest bid.

When the negotiation is open, buyers submit proposals with the price instantiated to its bid value. At the deadline, the auctioneer identifies the highest bidding buyer, and forms agreement between the highest bidding buyer and the seller. It finally notifies both parties.

For a multiple item continuous double auction, for example the stock exchange, the actors (i.e. entities) are traders as participants and the market maker as the negotiation host. The negotiation locale is the exchange floor. An example of admission policy, negotiation template and rules are:

Admission Policy

Either the null policy—anyone is admitted—or admission on presentation of credentials such as qualified trader.

Negotiation Template

The market maker decides on the template of goods that are traded in the exchange. This will be fully defined, specifying all details exactly, except for the price attribute and quantity attribute, which will be open. To be valid with respect to the negotiation template, proposals must therefore be a copy of the proposal template, with price and quantity instantiated to specific values.

Negotiation Rules

The market maker adopts continuous double auction negotiation rules. These state that:

Posting rule—Buyers and sellers may post proposals at any time.

Improvement rule—The price field of a buyer's proposal must be above the value of all currently posted buyer proposals. The price field of a seller's proposal must be below the value of all currently posted seller proposals.

Withdrawal rule—Any proposal can be withdrawn at any moment, before an agreement is formed that involves it.

Visibility rule—Proposals are only visible to the market maker, in order to protect the participants from receiving too much information.

Display rule—The market maker regularly updates the order books, containing information on proposals to buy and to sell, ordered by price.

Termination rule—Termination occurs only when the auction ceases to be used.

Agreement Formation Rules

The market maker adopts continuous double auction agreement formation rules. These state that:

Agreement formation rule—Agreement is formed between all overlapping buyers and sellers. The price is the midpoint of the overlap. Highest buyers and lowest sellers are satisfied first. When traders have different quantities, this may result in a single party having trades with several others (multiple agreements).

Tie breaking rule—In case of ties, earlier proposals have priority.

During negotiation, the traders continuously exchange proposals. Agreement formation occurs whenever there is an overlap between buyers and sellers proposals, according to the rules above. Participants are notified of any agreements made.

What is claimed:

1. A computer system for allowing negotiation between a plurality of entities, the computer system comprising a computer network having a plurality of computer nodes; a computer node being arranged to define the negotiation between the entities with a set of negotiation activities; wherein the computer node is operable to implement a plurality of negotiation rule sets, each rule set constraining the set of negotiation activities to a specific negotiation type, thereby allowing an entity to select at least one of a plurality of negotiation types.

2. A computer system according to claim 1, wherein a plurality of nodes are arranged to define the negotiation between the entities with a set of negotiation activities; wherein each of the plurality of nodes are operable to implement a plurality of negotiation rule sets.

3. A computer system according to claim 1, wherein at least one of the entities is a software negotiation agent.

4. A computer system according to claim 3, wherein the computer node incorporates the software negotiation agent.

5. A computer system according to claim 1, wherein at least one of the entities is a user.

6. A computer system according to claim 1, wherein in at least one of the entities is a negotiation host and at least another of the entities is a negotiation participant.

7. A computer system according to claim 1, wherein at least one of the rule sets constrains the negotiation activities to an auction and at least another rule set constrains the negotiation activities to a one on one negotiation.

8. A computer system according to claim 1, wherein the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

9. A computer system according to claim 8, wherein the negotiation activities further includes a protocol enforcer for rejecting invalid proposals.

10. A computer system according to claim 9, wherein the negotiation activities further includes an information editor for providing to the negotiation locale summarized proposal information.

11. A computer system according to claim 10, wherein the negotiation activities further includes an agreement maker for determining criteria for establishing an agreement based on the received proposals.

12. A computer node for coupling to a computer system to allow negotiation between a plurality of entities, the computer node comprising a processor, the processor being arranged to define the negotiation between the entities with a set of negotiation activities; wherein the processor is operable to implement a plurality of negotiation rule sets, each rule set constraining the set of negotiation activities to a specific negotiation type, thereby allowing an entity to select at least one of a plurality of negotiation types.

13. A computer node according to claim 12, wherein at least one of the entities is a software negotiation agent.

14. A computer node according to claim 13, wherein the computer node incorporates the software negotiation agent.

15. A computer node according to claim 12, wherein at least one of the entities is a user.

16. A computer node according to claims 12, wherein in at least one of the entities is a negotiation host and at least another of the entities is a negotiation participant.

17. A computer node according to claims 12, wherein at least one of the rule sets constrains the negotiation activities to an auction and at least another rule set constrains the negotiation activities to a one on one negotiation.

18. A method for selecting a negotiation type between a plurality of entities via a computer network having a plurality of computer nodes, the method comprising defining in a computer node a set of negotiation activities; allowing an entity to select via the computer node at least one of a plurality of negotiation rule sets, each rule set constraining the set of negotiation activities to a specific negotiation type, thereby allowing an entity to select at least one of a plurality of negotiation types.

19. A computer system for allowing negotiation between a plurality of entities, the computer system comprising a computer network having a plurality of computer nodes; a computer node being arranged to define the negotiation between the entities with a set of negotiation activities; wherein the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

20. A computer system according to claim 19, wherein the negotiation activities further includes a protocol enforcer for rejecting invalid proposals.

21. A computer system according to claim 20, wherein the negotiation activities further includes an information editor for providing to the negotiation locale summarized proposal information.

22. A computer system according to claim 21, wherein the negotiation activities further includes an agreement maker for determining criteria for establishing an agreement based on the received proposals.

23. A computer node for coupling to a computer system to allow negotiation between a plurality of entities, the computer node comprising a processor, the processor being arranged to define the negotiation between the entities with a set of negotiation activities; wherein the negotiation activities include a proposal validator for validating a proposal, received from an entity, with an agreement template, a negotiation locale for providing a validated proposal to a proposal compatibility checker for comparing proposals received from the negotiation locale to determine compatibility of received proposals to establish an agreement.

24. A computer node according to claim 23, wherein the negotiation activities further includes a protocol enforcer for rejecting invalid proposals.

25. A computer node according to claim 24, wherein the negotiation activities further includes an information editor for providing to the negotiation locale summarized proposal information.

26. A computer node according to claim 25, wherein the negotiation activities further includes an agreement maker for determining criteria for establishing an agreement based on the received proposals.
